(19) United States
(12) Patent Application Publication
(10) Pub. No.: US 2020/0293857 A1
(43) Pub. Date: Sep. 17, 2020

(54) CNN PROCESSING DEVICE, CNN PROCESSING METHOD, AND PROGRAM

(71) Applicant: HONDA MOTOR CO., LTD., Tokyo (JP)

(72) Inventors: Kazuhiro Nakadai, Wako-shi (JP); Hirofumi Nakajima, Tokorozawa-shi (JP)

(21) Appl. No.: 16/809,050

(22) Filed: Mar. 4, 2020

(30) Foreign Application Priority Data
Mar. 15, 2019 (JP) 2019-048407

(51) Int. Cl. G06N 3/04; G06K 9/66; G06N 20/10; G06N 3/08; G06F 17/14

(52) U.S. Cl. CPC G06N 3/04; G06K 9/66; G06F 17/14; G06N 3/08; G06N 20/10

(57) ABSTRACT

A CNN processing device includes: a kernel storage unit configured to store kernels used in a convolution operation; a table storage unit configured to store a Fourier base function used in the convolution operation; and a convolution operation unit configured to model an element g in coefficients G of the kernels in a convolutional neural network (CNN) using N-order (N is an integer equal to or greater than 1) Fourier series expansion and to perform a convolution operation on processing target information that is information on a processing target through a CNN method using the kernels and the Fourier base function.

### CROSS-REFERENCE TO RELATED APPLICATION

Priority is claimed on Japanese Patent Application No. 2019-048407, filed Mar. 15, 2019, the content of which is incorporated herein by reference.

### BACKGROUND OF THE INVENTION

### Field of the Invention

The present invention relates to a CNN processing device, a CNN processing method, and a program.

### Description of Related Art

Recently, machine learning has attracted attention. For example, algorithms such as decision tree learning, neural networks and Bayesian networks are used in machine learning. In addition, neural networks include a feedforward neural network, a convolutional neural network (CNN), and the like. A convolutional neural network is used for image recognition, moving image recognition, and the like, for example.

As an operation device for a CNN, a device including a first calculator which specifies input values multiplied by elements in a convolution operation from among input values included in input data for respective elements of a kernel used in a convolution operation and calculates the sum of the specified input values, and a second calculator which calculates, for respective elements of the kernel, products of the sum calculated by the first calculator for the elements and the elements and calculates the average of the calculated products has been proposed (refer to Japanese Unexamined Patent Application, First Publication No. 2017-78934 (hereinafter, Patent Document 1), for example).

### SUMMARY OF THE INVENTION

However, in conventional technologies disclosed in Patent Document 1 and the like, a convolution operation amount increases according to the number of kernels and the number of pixels of kernels.

An object of aspects of the present invention devised in view of the aforementioned problem is to provide a CNN processing device, a CNN processing method, and a program which can reduce an operation amount as compared to conventional technologies.

To accomplish the aforementioned object, the present invention employs the following aspects.

(1) A CNN processing device according to one aspect of the present invention includes: a kernel storage unit configured to store kernels used in a convolution operation; a table storage unit configured to store a Fourier base function used in the convolution operation; and a convolution operation unit configured to model an element g in coefficients G of the kernels in a convolutional neural network (CNN) using N-order (N is an integer equal to or greater than 1) Fourier series expansion and to perform a convolution operation on processing target information that is information on a processing target through a CNN method using the kernels and the Fourier base function.

(2) In the aspect (1), exp(inθₖ) is an n-order Fourier base function, θₖ (k is an integer between 1 and K and K is the number of kernels) corresponds to an element having periodicity in filter coefficients of the CNN, c_{n,m} is a Fourier coefficient, and the element g is g_{k,m} (m is an integer between 1 and M and M is a total number of pixels of the kernels), and the convolution operation unit may calculate the element g_{k,m} in the CNN using the following Equation.

$${g}_{k , m} = {\sum }_{n = - N}^{N} {c}_{n , m} exp ( in {θ}_{k} )$$

(3) In the aspect (2), the convolution operation unit may calculate an image Y after the convolution operation by multiplying a matrix of the Fourier base function having K rows and (2N+1) columns by a matrix of the Fourier coefficients having (2N+1) rows and M columns.

(4) In the aspect (2) or (3), the convolution operation unit may select N for which (M+K)(2N+1) is smaller than (M×K).

(5) A CNN processing method according to one aspect of the present invention is a CNN processing method in a CNN processing device including a kernel storage unit configured to store kernels used in a convolution operation and a table storage unit configured to store a Fourier base function used in the convolution operation, the CNN processing method including: a processing procedure through which a convolution operation unit models an element g in coefficients G of the kernels in a convolutional neural network (CNN) using N-order (N is an integer equal to or greater than 1) Fourier series expansion and performs a convolution operation on processing target information that is information on a processing target through a CNN method using the kernels and the Fourier base function.

(6) A computer-readable non-transitory storage medium according to one aspect of the present invention stores a program causing a computer of a CNN processing device including a kernel storage unit configured to store kernels used in a convolution operation and a table storage unit configured to store a Fourier base function used in the convolution operation to execute a processing procedure of modeling an element g in coefficients G of the kernels in a convolutional neural network (CNN) using N-order (N is an integer equal to or greater than 1) Fourier series expansion and performing a convolution operation on processing target information that is information on a processing target through a CNN method using the kernels and the Fourier base function.

According to the aspect (1), (5) or (6), it is possible to reduce an operation amount of transfer characteristics because an element g in kernel coefficients in a CNN is modeled using N-order (N is an integer equal to or greater than 1) Fourier series expansion.

According to the aspects (2) and (3), it is possible to reduce an operation amount of convolution processing in a CNN by calculating Fourier coefficients using the aforementioned Equation.

According to the aspect (4), it is possible to reduce an operation amount of convolution processing in a CNN as compared to conventional technologies because N less than (M×K) is selected for (M+K)(2N+1).

### BRIEF DESCRIPTION OF THE DRAWINGS

FIG. 1 is a diagram for explaining an overview of image processing using a CNN.

FIG. 2 is a block diagram showing an example of a configuration of an information processing apparatus according to an embodiment.

FIG. 3 is a diagram showing an example of an image processing procedure using a CNN.

FIG. 4 is a diagram showing an example of a kernel of 5×5 pixels.

FIG. 5 is a flowchart of processing of an information processing apparatus according to an embodiment

FIG. 6 is a diagram showing an example of CNN processing in speech recognition according to the present embodiment.

### DETAILED DESCRIPTION OF THE INVENTION

Hereinafter, an embodiment of the present invention will be described with reference to the drawings. Images, pixels and the like are represented in sizes that can be perceived in the drawings below used for description, and thus scales of images, pixels and the like are appropriately changed.

First, an overview of image processing using a convolutional neural network (CNN) (hereinafter referred to as a CNN) will be described.

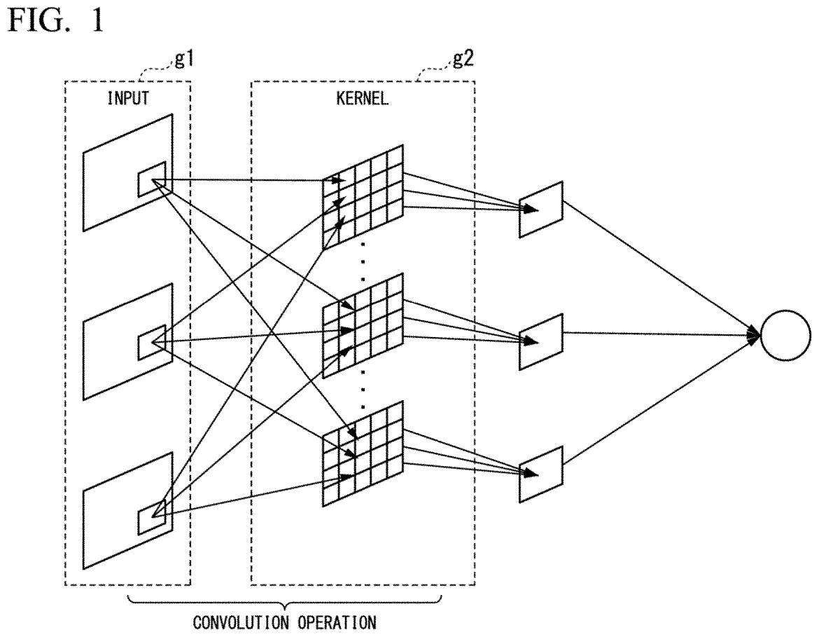

FIG. 1 is a diagram for explaining an overview of image processing using a CNN. In FIG. 1, a reference sign g1 represents an input image and a reference sign g2 represents a kernel.

In image processing, convolution processing involves calculating the sum of products of numeral data in a lattice form called a kernel (filter) and numeral data of partial images (windows) having the same size as the kernel for each element to convert numeral data into one numerical value. This conversion processing is performed while gradually shifting windows to convert the input into numerical data in a small lattice form.

In such processing, windows having the same size as the kernel are extracted from input images, elements are multiplied, and then all multiplication results are summed up to calculate one numerical value (first convolution processing), for example. Input images may be a plurality of feature images extracted from an acquired image, for example.

Next, an extracted window is shifted 3 pixels to the right, for example, to newly calculate one numerical value (second convolution processing). When calculation is performed by shifting the window 3 pixels to the right in the same manner, n (=N pixels/3 pixels) pieces of numerical data are generated in one row. Upon arrival at the right end, processing returns to the leftmost end and calculation is performed while shifting 3 pixels downward and shifting 3 pixels to the right in the same manner. For example, when an image processing target is 32×32 pixels, n=10 and the 32×32 pixels are scaled down to 10×10 pixels through convolution. Then, a feature map output from convolution processing is further scaled down through pooling processing to obtain a new feature map.

When an object included in an input image is predicted, prediction may be performed by outputting a probability using a Softmax function, for example, using all obtained feature quantities.

### Configuration of Information Processing Apparatus

Next, an example of a configuration of an information processing apparatus will be described.

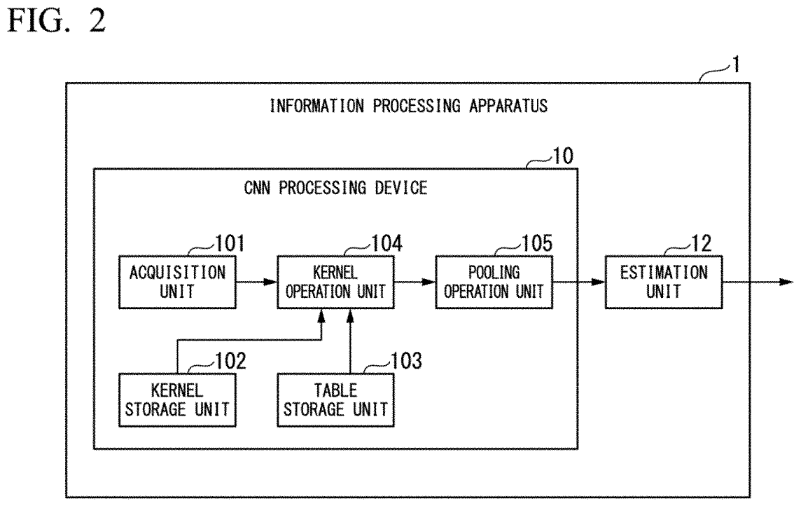

FIG. 2 is a block diagram showing an example of a configuration of an information processing apparatus 1 according to the present embodiment. As shown in FIG. 2, the information processing apparatus 1 includes a CNN processing device 10 and an estimation unit 12. The CNN processing device 10 includes an acquisition unit 101, a kernel storage unit 102, a table storage unit 103, a convolution operation unit 104, and a pooling operation unit 105.

The information processing apparatus 1 may be an image recognition apparatus, for example. The information processing apparatus 1 performs CNN processing on an acquired image to recognize an object included in the acquired image.

The acquisition unit 101 acquires an image from an external device (e.g., an imaging device or the like) and outputs the acquired image to the convolution operation unit 104.

The kernel storage unit 102 stores kernels.

The table storage unit 103 stores values (a Fourier base function exp(inθₖ) which will be describe later) necessary for the convolution operation unit 104 to perform an operation in a table format.

The convolution operation unit 104 performs convolution operation processing on the image acquired by the acquisition unit 101 using kernels stored in the kernel storage unit 102 and values stored in the table storage unit 103. The convolution operation unit 104 outputs operation results to the pooling operation unit 105.

The pooling operation unit 105 performs pooling processing for further scaling down the operation results output from the convolution operation unit 104 to calculate new feature quantities. Pooling processing is processing of creating one numerical value from numerical data of a window. Pooling processing may include, for example, maximum value pooling for selecting a maximum value in a window, average pooling for selecting an average in a window, and the like.

The estimation unit 12 predicts an object included in an input image by outputting a probability using a Softmax function, for example, for feature quantities output from the pooling operation unit 105.

### Example of Image Processing using CNN

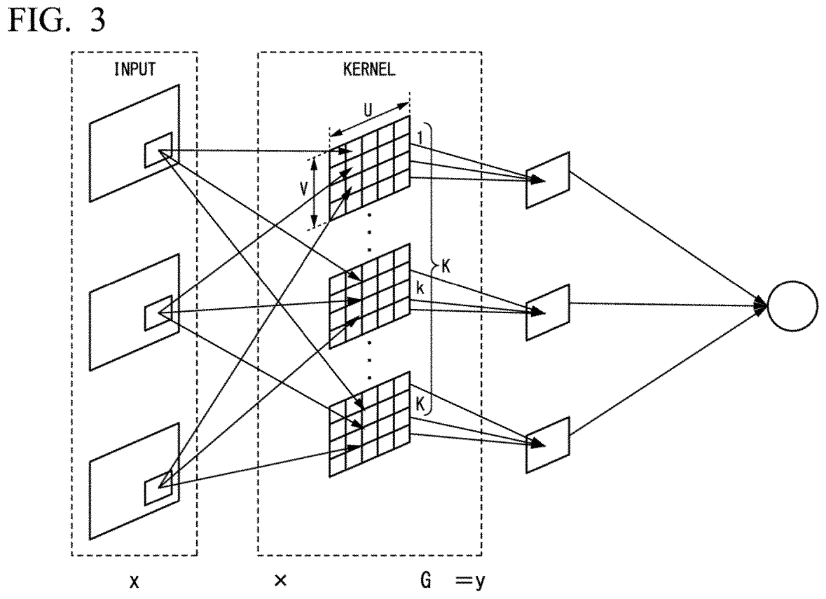

FIG. 3 is a diagram showing an example of an image processing procedure using a CNN. Some suffixes are omitted in FIG. 3.

In FIG. 3, input images are represented by X(i, j) wherein i represents an index of a pixel in the horizontal direction of an image and j represents an index of the pixel in the vertical direction of the image. In addition, K represents the number of kernels and k represents a k-th kernel. Further, U represents a size (pixels) in the horizontal direction of a kernel and V represents a size (pixels) in the vertical direction of the kernel.

Further, when coefficients of the k-th kernel are Gₖ(n, m), an image Yₖ(i, j) after a convolution operation can be represented by Equation (1) below. Additionally, n is an X-coordinate index of a two-dimensional filter and m is a Y-coordinate index of the two-dimensional filter in Gₖ(n, m).

Yₖ(i,j)=Σᵥ₌₀^{V-1}Σᵤ₌₀^{U-1}Gₖ(u,k)X(i+u,j+v) (1)

Here, 1 pixel (i, j) of an output image is focused on and (i, j) is omitted hereinafter. The element y in Equation (1) can be represented by the following Equation (2).

y=Gx (2)

In addition, Equation (2) can be represented as the following Equation (3) using a matrix and a vector.

$$[ \begin{matrix}{y}_{1} \\ {y}_{2} \\ ⋮ \\ {y}_{K}\end{matrix} ] = [ \begin{matrix}{g}_{1 , 1} & \text{...} & {g}_{1 , M} \\ ⋮ & ⋱ & ⋮ \\ {g}_{K , 1} & \text{...} & {g}_{K , M}\end{matrix} ] [ \begin{matrix}{x}_{1} \\ {x}_{2} \\ : \\ {x}_{M}\end{matrix} ] \qquad ( 3 )$$

In addition, K is the number of kernels and M is a total number of pixels (=U×V) in Equation (3). In addition, in Equations (2) and (3), the element yₖ is represented by the following Equation (4), the element g_{m,k} is represented by the following Equation (5), and the element xₘ is represented by the following Equation (6).

yₖ=Yₖ(i,j) (4)

g_{m,k}=Gₖ(m mod U,└m/U┘) (5)

xₘ=Xₘ(i+(m mod U),j+└m/U┘) (6)

In Equations (5) and (6), (m mod U) represents a remainder after dividing m by U and the following Equation (7) represents a value obtained by making a into an integer by a Gauss symbol (floor function).

└a┘ (7)

Here, the matrix G is a matrix in which coefficients of respective kernels are arranged in the vertical direction as row vectors. Further, a kernel is a K-row M-column matrix in Equation (3).

Accordingly, in calculation using Equation (3), multiplication needs to be performed ML times. For example, when M=72 and K=32, multiplication needs to be performed 2,304 (=72×32) times.

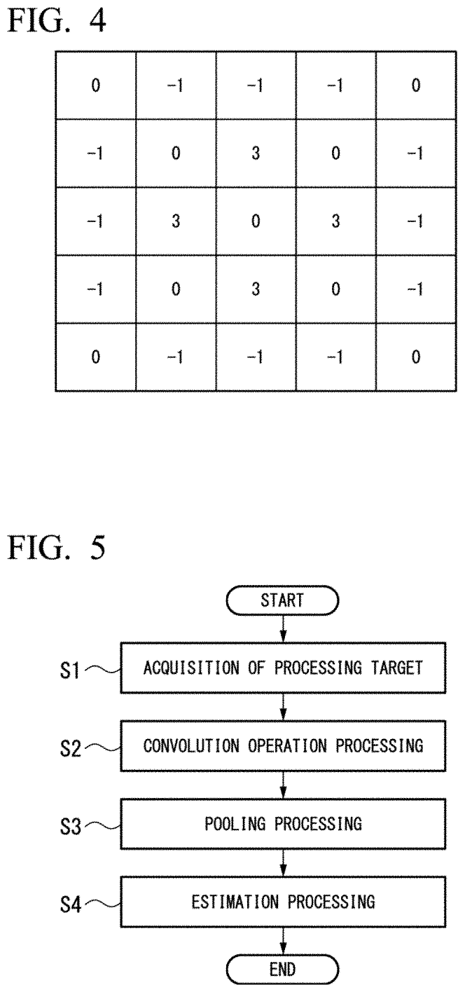

Here, many kernels use a periodic stripe pattern having different directions such as horizontal, vertical and diagonal directions, as shown in FIG. 4, for example. FIG. 4 is a diagram showing an example of a kernel of 5×5 pixels. In this case, a Fourier coefficient model is valid because values of each column vector have strong periodicity.

### Calculation of Transfer Characteristic According to Present Embodiment

Next, a method of calculating an element g_{k,m} according to the present embodiment will be described.

In the present embodiment, the convolution operation unit 104 models the element g_{k,m} using an N-order complex Fourier coefficient as represented by the following Equation (8). In addition, θₖ (k is an integer between 1 and K) in Equation (8) represents an angle of stripes of a pattern of filter coefficients at a k-th discrete time, for example. In this manner, θₖ corresponds to an element having periodicity in filter coefficients of a CNN, for example.

$${g}_{k , m} = {\sum }_{n = - N}^{N} {c}_{n , m} \cdot exp ( in {θ}_{k} ) \qquad ( 8 )$$

In Equation (8), c_{n,m} is a Fourier coefficient and i represents an imaginary unit. In addition, c_{n,m} and c_{-n,m} have a conjugate relation therebetween. Further, exp(in θₖ) is an n-order Fourier base function (sine base) and the calculation of the n-order Fourier base function is a process of only referring to a table prepared in advance. This table of the Fourier base function exp(inθₖ) is stored in advance in the table storage unit 103.

Equation (8) implies approximation of a function defined as a function in which the horizontal axis is k (discrete value) and the vertical axis is a Fourier coefficient using a Fourier series. For example, if a two-dimensional filter pattern is stripes having different angles, the angles of the stripes correspond to θₖ. In such a case, approximation accuracy increases.

### Method of Obtaining Fourier Coefficient c_{n,m}

Here, as an example, a method of determining a coefficient (cₙ(ω)) when a complex amplitude model given in Equation (8) is introduced for one-dimensional gₘ having only k as a variable will be described.

For θₗₖ(1=1, 2, 3, . . . , K), simultaneous equations of the following Equation (9) are obtained.

$${g}_{1} = {\sum }_{n = - N}^{N} {c}_{n} exp ( in {θ}_{1} ) \\ {g}_{2} = {\sum }_{n = - N}^{N} {c}_{n} exp ( i n {θ}_{2} ) \\ ⋮ \\ {g}_{K} = {\sum }_{n = - N}^{N} {c}_{n} exp ( i n {θ}_{K} ) \qquad ( 9 )$$

These simultaneous equations can be described using a matrix and a vector as represented by the following Equation (10).

g=Ac (10)

In Equation (10), c is a coefficient vector and A is a coefficient vector of the model. Respective vectors are represented by the following Equations (11) to (13).

g=[g₁g₂ . . . g_{K}]^{T} (11)

c=[c_{-N}c_{-N+1} . . . c₋₁c₋₀c₁ . . . c_{N}]^{T} (12)

A=[a1^{T} a2^{T} . . . ak . . . aK^{T}]^{T} (13)

In Equation (13), ak is represented by the following Equation (14).

ak=[exp(−iNθₖ) . . . exp(−i(N−1)θₖ) . . . exp(−iθₖ)l exp(iθₖ) . . . exp(iNθₖ)]^{T} (14)

A coefficient vector c to be obtained can be acquired as the following Equation (15) from Equation (10).

c=A⁺g (15)

In Equation (15), A⁺ is a pseudo inverse matrix (Moore Penn Lowe's pseudo inverse matrix) of A. When the number K of simultaneous equations is greater than the number 2N+1 of variables (when K>2N+1), in general, a coefficient vector is acquired as a solution by which the sum of squares of errors is minimized according to Equation (15). In addition, otherwise (when K≤2N+1), a coefficient vector is acquired as a solution of which a norm is minimized from among the solutions of Equation (3).

Next, the element yₖ can be calculated as represented by the following Equation (16).

$$\begin{matrix}{y}_{k} = {\sum }_{m = 1}^{M} {x}_{m} \{ {\sum }_{n = - N}^{N} {c}_{n , m} \cdot exp ( in {θ}_{k} ) \} \\ = {\sum }_{m = 1}^{M} {\sum }_{n = - N}^{N} \{ {x}_{m} {c}_{n , m} \cdot exp ( in {θ}_{k} ) \} \\ = {\sum }_{n = - N}^{N} {\sum }_{n = - N}^{N} \{ {x}_{m} {c}_{n , m} \cdot exp ( in {θ}_{k} ) \} \\ = {\sum }_{n = - N}^{N} exp ( in {θ}_{k} ) {\sum }_{n = - N}^{N} {x}_{m} {c}_{n , m}\end{matrix} \qquad ( 16 )$$

Equations (3) and (16) are represented with matrixes and vectors as represented by the following Equation (17).

$$[ \begin{matrix}{g}_{1 , 1} & \text{...} & {g}_{M , 1} \\ ⋮ & ⋱ & ⋮ \\ {g}_{1 , K} & \text{...} & {g}_{M , K}\end{matrix} ] = [ \begin{matrix}exp ( - iN {θ}_{1} ) & … & exp ( - iN {θ}_{1} ) \\ ⋮ & ⋱ & ⋮ \\ exp ( - iN {θ}_{K} ) & … & exp ( - iN {θ}_{K} )\end{matrix} ] - [ \begin{matrix}{c}_{1 , - N} & … & {c}_{M , - N} \\ ⋮ & ⋱ & ⋮ \\ {c}_{1 , N} & … & {c}_{M , N}\end{matrix} ] \qquad ( 17 )$$

In Equation (17), the number of rows is K and the number of columns is M on the left side. In addition, the first term of the right side is Fourier base functions in which the number of rows is K (the number of discretization angles) and the number of columns is 2N+1 (the number of Fourier series). Further, the second term of the right side is Fourier coefficients in which the number of rows is 2N+1 (the number of Fourier series) and the number of columns is M.

Here, Equation (17) is assumed to be g=Sc.

When calculated using a Fourier model, the element yₖ can be represented as yₖ=gx=Scx=S(cx).

S is a matrix having K rows and (2N+1) columns as represented by Equation (17) and requires K(2N+1) multiplications. In addition, c is a matrix having (2N+1) rows and M columns as represented by Equation (17) and requires (2N+1)M multiplications. Accordingly, the sum of the numbers of multiplications of Equation (17) is (M+K)(2N+1).

The convolution operation unit 104 may allow N less than (M×K) to be selected for (M+K)(2N+1). As a result, according to the present embodiment, an operation amount in a CNN can be reduced as compared to conventional technologies.

### Processing Procedure

Next, an example of a processing procedure of the information processing apparatus 1 will be described.

FIG. 5 is a flowchart of processing of the information processing apparatus 1 according to the present embodiment.

(Step S1) The acquisition unit 101 acquires an image that is a processing target.

(Step S2) The convolution operation unit 104 extracts partial images (windows) from the acquired image. Subsequently, the convolution operation unit 104 performs convolution operation processing using the extracted partial images, kernels stored in the kernel storage unit 102 and a Fourier base function stored in the table storage unit to calculate an image after the convolution operation processing. The convolution operation unit 104 performs the convolution operation processing by modeling kernel coefficients in a CNN using N-order (N is an integer equal to or greater than 1) Fourier series expansion as described above.

(Step S3) The pooling operation unit 105 performs pooling processing for further scaling down the operation result obtained by the convolution operation unit 104 to calculate new feature quantities.

(Step S4) The estimation unit 12 predicts an object included in the input image by outputting a probability using a Softmax function, for example, for the feature quantities calculated by the pooling operation unit 105.

In the aforementioned modeling using N-order Fourier coefficients, other methods such as Taylor expansion and spline interpolation may be used in addition to Fourier series expansion.

As described above, according to the present embodiment, the operation amount of convolution processing can be reduced because kernel coefficients in a CNN are modeled using N-order (N is an integer equal to or greater than 1) Fourier series expansion. In addition, according to the present embodiment, the amount of data stored in the kernel storage unit 102 can be reduced as compared to conventional technologies because modeling using N-order (N is an integer equal to or greater than 1) Fourier series expansion is performed.

Although an example in which modeling using N-order Fourier coefficients is performed for the number of pixels (M) and the number of kernels (K) in a kernel has been described in the above-described example, the present invention is not limited thereto. M may be the number of color spaces in color spaces such as RGB, CYMK and the like in image processing. In addition, M may be the number of images (channels) input to a convolutional layer.

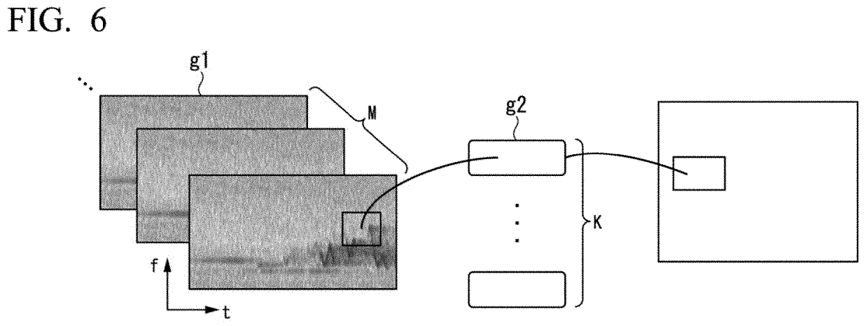

In addition, although an example in which the information processing apparatus 1 of the present embodiment is used for image processing such as image recognition has been described in the above-described example, the present invention is not limited thereto. For example, the information processing apparatus 1 of the present embodiment may also be applied to speech recognition processing as shown in FIG. 6. FIG. 6 is a diagram showing an example of CNN processing in speech recognition according to the present embodiment. In FIG. 6, reference sign g1 represents a spectrogram obtained by converting an acquired audio signal into a frequency region. Further, in the reference sign g1, the horizontal direction represents time and the vertical direction represents frequency. In addition, reference sign g2 represents a kernel.

When the information processing apparatus 1 is applied to this speech recognition, M may also be applied as a total number of pixels of a kernel, as described above. In this case, M is the number of spectrograms and K is the number of kernels. Further, a case in which the number of pixels of spectrograms is M and the number of kernels is K can be represented in the same manner as Equations (4) to (6). In this case, processing such as speech identification may be performed by calculating a spectrogram representing a speech signal as a frequency spectrum and performing image processing on this spectrogram using the information processing apparatus 1.

In addition, when M is the number of color spaces such as RGB, the method of the present embodiment can be applied by performing respective processes in RGB in parallel, recognizing process results and integrating the same or performing processing such as converting RGB into YUV (image of luminance-hue-chroma) and abandoning colors or processing colors in parallel and finally integrating the same, for example.

A program for realizing all or some functions of the information processing apparatus 1 in the present invention may be recorded in a computer-readable recording medium, and all or some processes performed by the information processing apparatus 1 may be performed by a computer system reading and executing the program recorded in this recording medium. The “computer system” mentioned here is assumed to include an OS and hardware such as peripheral apparatuses. In addition, the “computer system” is assumed to also include a WWW system including a homepage providing environment (or a display environment). Furthermore, the “computer-readable recording medium” refers to a portable medium such as a flexible disc, a magneto-optical disc, a ROM or a CD-ROM, or a storage device such as a hard disk included in a computer system. Moreover, the “computer-readable recording medium” is assumed to also include a medium which stores a program for a certain time like a volatile memory (RAM) in a computer system which serves as a server or a client when a program is transmitted through a network such as the Internet or a communication link such as a telephone circuit.

In addition, the aforementioned program may be transmitted from a computer system which stores this program in a storage device or the like to other computer systems through a transmission medium or according to transmitted waves in a transmission medium. Here, the “transmission medium” which transmits a program refers to a medium having a function of transmitting information like a network (communication network) such as the Internet or a communication link such as a telephone circuit. Furthermore, the aforementioned program may realize some of the above-described functions. Moreover, the aforementioned program may be a program which can realize the above-described functions according to a combination with a program already recorded in a computer system, a so-called a difference file (difference program).

While forms for embodying the present invention have been described using embodiments, the present invention is not limited to these embodiments and various modifications and substitutions can be made without departing from the spirit or scope of the present invention.

What is claimed is:

1. A CNN processing device comprising:
a kernel storage unit configured to store kernels used in a convolution operation;
a table storage unit configured to store a Fourier base function used in the convolution operation; and
a convolution operation unit configured to model an element g in coefficients G of the kernels in a convolutional neural network (CNN) using N-order (N is an integer equal to or greater than 1) Fourier series expansion and to perform a convolution operation on processing target information that is information on a processing target through a CNN method using the kernels and the Fourier base function.

2. The CNN processing device according to claim 1, wherein exp(inθₖ) is an n-order Fourier base function, θₖ (k is an integer between 1 and K and K is the number of kernels) corresponds to an element having periodicity in filter coefficients of the CNN, c_{n,m} is a Fourier coefficient, and the element g is g_{k,m} (m is an integer between 1 and M and M is a total number of pixels of the kernels), and
wherein the convolution operation unit calculates the element g_{k,m} in the CNN using the following Equation.
$${g}_{k , m} = {{\sum }_{n = - N}}^{N} {c}_{n , m} exp ( i n {θ}_{k} )$$

3. The CNN processing device according to claim 2, wherein the convolution operation unit calculates an image Y after the convolution operation by multiplying a matrix of the Fourier base function having K rows and (2N+1) columns by a matrix of the Fourier coefficients having (2N+1) rows and M columns.

4. The CNN processing device according to claim 2, wherein the convolution operation unit selects N for which (M+K)(2N+1) is smaller than (M×K).

5. A CNN processing method in a CNN processing device including a kernel storage unit configured to store kernels used in a convolution operation and a table storage unit configured to store a Fourier base function used in the convolution operation, the CNN processing method comprising;
a processing procedure through which a convolution operation unit models an element g in coefficients G of the kernels in a convolutional neural network (CNN) using N-order (N is an integer equal to or greater than 1) Fourier series expansion and to perform a convolution operation on processing target information that is information on a processing target through a CNN method using the kernels and the Fourier base function.

6. A computer-readable non-transitory storage medium storing a program causing a computer of a CNN processing device including a kernel storage unit configured to store kernels used in a convolution operation and a table storage unit configured to store a Fourier base function used in the convolution operation to execute:
a processing procedure of modeling an element g in coefficients G of the kernels in a convolutional neural network (CNN) using N-order (N is an integer equal to or greater than 1) Fourier series expansion and performing a convolution operation on processing target information that is information on a processing target through a CNN method using the kernels and the Fourier base function.
